(19) United States
(12) Patent Application Publication
(10) Pub. No.: US 2017/0255948 A1
(43) Pub. Date: Sep. 7, 2017

(54) Business to Consumer Enterprise Software System

(71) Applicant: McNabb Technologies, LLC, Chicago, IL (US)

(72) Inventor: Ritchie Hale, Chicago, IL (US)

(21) Appl. No.: 15/446,690

(22) Filed: Mar. 1, 2017

Related U.S. Application Data
(60) Provisional application No. 62/301,845, filed on Mar. 1, 2016.

(51) Int. Cl. G06Q 30/02; H04L 12/58; G06Q 30/00; G06Q 20/32; G06Q 30/06; G06Q 10/08

(52) U.S. Cl. CPC G06Q 30/0201; G06Q 30/0635; G06Q 10/083; G06Q 30/0185; G06Q 20/325; H04L 51/22

(57) ABSTRACT

A business to consumer enterprise software system having a computer having a memory and a processor and non-transitory computer-readable instructions stored in the memory when executed by the processor provides a service cloud, a marketing cloud, a customer acquisition cloud, and a community cloud.

### CROSS-REFERENCE TO RELATED APPLICATIONS

This application claims priority to U.S. provisional application Ser. No. 62/301,845 filed Mar. 1, 2016, entitled “Business to Consumer Enterprise Software System,” which is hereby incorporated by reference herein in its entirety.

### FIELD OF THE INVENTION

A system for providing a customer acquisition, monetization and retention enterprise platform designed for small to large businesses providing a direct to consumer sales and marketing experience is described.

### BACKGROUND OF THE INVENTION

Companies who “live” in the online marketing and sales arena need a software system that provides a significant competitive advantage by improving customer understanding, robust activity measure, and value tracking and engagement. Such system should provide for simplicity of customer management, 360 degree customer visibility across multiple brands, full customer value analysis, easy access to data for quick business decisions, and real-time dashboards for continuous business assessment.

### SUMMARY OF THE INVENTION

A business to consumer enterprise software system having a computer having a memory and a processor and non-transitory computer-readable instructions stored in the memory when executed by the processor provides a service cloud, a marketing cloud, a customer acquisition cloud, and a community cloud.

Aspects of the present disclosure include a business to consumer enterprise software system comprising a computer having a memory and a processor, and non-transitory computer-readable instructions stored in the memory. When the instructions are executed by the processor, the instructions provide a service cloud for order processing, auto-ship management, reporting, customer value tracking, marketing tracking, call center console, lead manager, fraud alert and payment processing; a marketing cloud for customer journey and customer segmentation; a customer acquisition cloud for sales funneling, and sales funnel development; a community cloud to provide a customer shopping cart, a customer self-service function, and an incremental sales system; and an analytics cloud to provide segmentation and analysis of customer data points.

Additional aspects of the present disclosure include a method of analyzing a customer profile within a business to consumer enterprise software system, the software system providing a service cloud, a marketing cloud, a customer acquisition cloud, a community cloud, and an analytics cloud. The method comprises obtaining customer data, the customer data including transactional data and non-transactional data, transforming a first subset of customer data from a first type to a second type, both the first type and the second type of the first subset of customer data being stored in the customer profile, transforming a second subset of customer data from a third type to a fourth type, both the third type and the fourth type of the second subset of customer data being stored in the customer profile, transforming a third subset of customer data from a fifth type to a sixth type, both the fifth type and the sixth type of the third subset of customer data being stored in the customer profile, sending the first type of the first subset of customer data to at least one of the service cloud, the marketing cloud, the customer acquisition cloud, or the community cloud, sending the second type of the first subset of customer data to the analytics cloud, sending the third type of the second subset of customer data to at least one of the service cloud, the customer acquisition cloud, the community cloud, or the analytics cloud, sending the fourth type of the second subset of customer data to the marketing cloud, sending the fifth type of the third subset of customer data to at least one of the service cloud, the customer acquisition cloud, the community cloud, or the analytics cloud, and sending the sixth type of the third subset of customer data to the marketing cloud.

Further aspects of the present invention include a logical table for organizing a plurality of product categories, the logical table comprising a plurality of rows, each row of the plurality of rows corresponding to a respective category of products, each row having a respective parent row corresponding to a respective parent category of products, and a plurality of columns intersecting the plurality of rows to define a plurality of cells, each row having a respective sub-plurality of cells, wherein each respective sub-plurality of cells includes information related to the category of products corresponding to each row, the information including a product category name, a product category activation date, a date last modified, and a respective parent category reference, the respective parent category reference indicating the respective parent row of each row.

### BRIEF DESCRIPTION OF THE DRAWINGS

To understand the present invention, it will now be described by way of example, with reference to the accompanying Figures in which:

FIG. 1 is a diagram of the software modules of the enterprise software system.

FIG. 2 is a diagram of a customer profile according to aspects of the present invention.

FIG. 3 is process flow map of the software modules of the enterprise software system.

FIG. 4 is a screen-shot of a graphical user interface tool to enable the creation of sales funnels pages without coding using HTML drag and drop development interface.

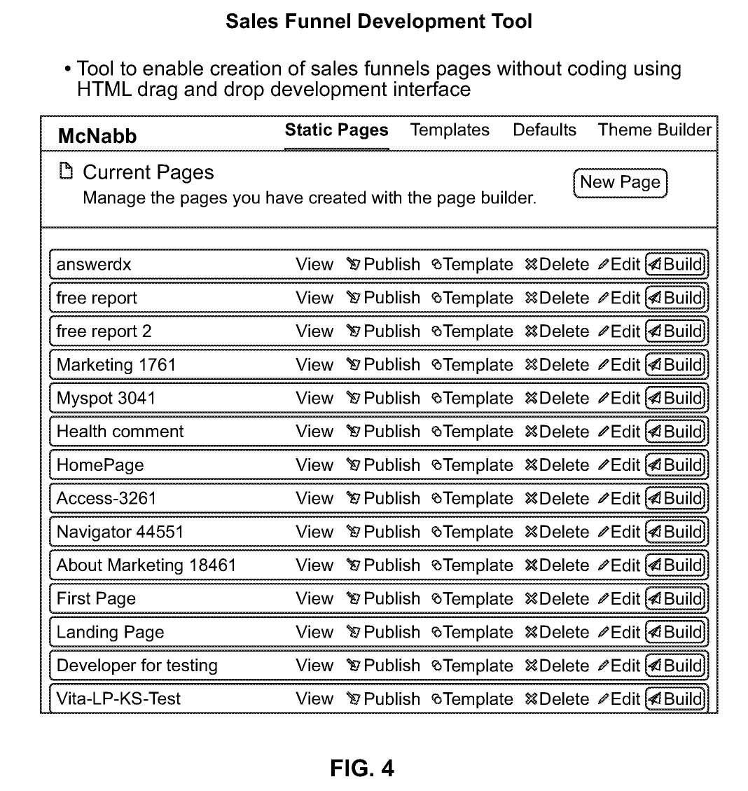

FIG. 5 is an exemplary self-referential table for use with the modules of the enterprise software system.

### DETAILED DESCRIPTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

Software systems for companies that utilize online marketing and sales are vitally important in providing insight into customers and potential customers. Ideally, the software system will provide the company with the ability to analyze data on customers to determine trends and other potential avenues at increasing sales or recruiting new customers.

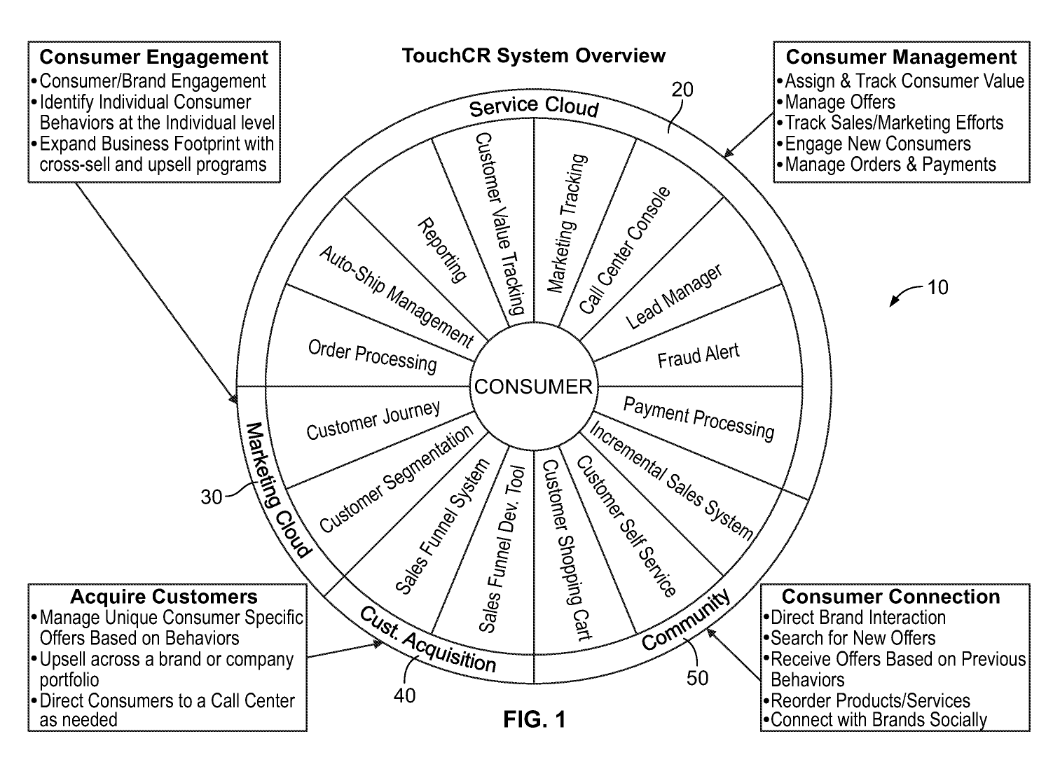

FIG. 1 is a diagram 10 showing a representation of software modules of the present invention organized in four areas. The areas include a service cloud 20, a marketing cloud 30, a customer acquisition cloud 40, and a community cloud 50. The present invention also includes an analytics cloud The service cloud 20 manages existing customers and provides customer support for existing customers. The service cloud 20 has specific modules for consumer management including assigning and tracking consumer value, managing offers, tracking sales and marketing efforts, engaging new consumers, and managing orders and payments. The marketing cloud 30 manages marketing strategies and activities for customers and helps the company interact with customers in different mediums, such as through email, text messaging, phone calls, social media, or other similar platforms. Marketing cloud 30 has software modules for engaging consumers and brands, identifying individual consumer behavior, and expanding a business footprint by facilitating cross-sell and upsell programs. The customer acquisition cloud 40 allows for managing unique consumer-specific offer based on a consumer's individual behavior, facilitates upselling across a brand or company product and service portfolio, and provides a call center to service the needs of consumers. The community cloud 50 allows the company to create a variety of communities within a customer database. This allows different customers to interact with both the customer and other members of the community (i.e. other customers). The community cloud 50 also enables communities to be created that include employees of the company or corporate partners. Community cloud 50 facilitates connecting consumers directly with specific brands, searching for new offers, receiving new offers based on previous behaviors, reordering products and services, and connecting with brands in social media. The system also includes an application cloud 60 that is a platform for developing apps, management and instant scaling of apps, and production of apps, and an analytics cloud (not shown) that allows for analysis of customer data in a friendly point and click environment that allows any data point to be analyzed and segmented against any other data point.

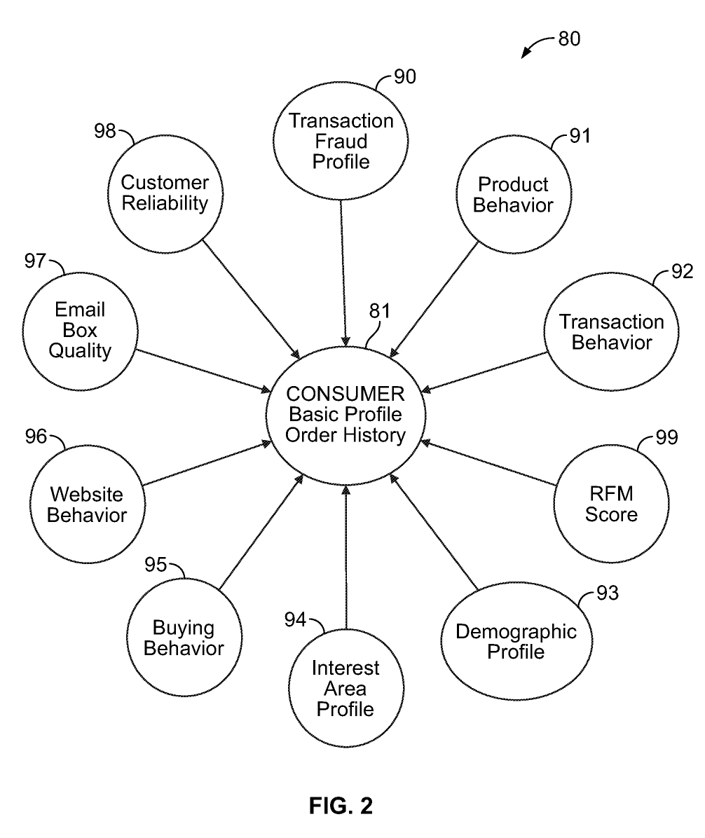

Referring now to FIG. 2, a customer database 80 is shown. The customer database 80 generally includes a customer profile 81 for a plurality of customers. Each of the service cloud 20, marketing cloud 30, customer acquisition cloud 40, community cloud 50, application cloud 60, and the analytics cloud utilize customer data that is stored in the customer profile 80. Each customer profile includes a plurality of data layers that offer information about a given customer. The data layers include a transaction fraud profile layer 90, a product behavior layer 91, a transaction behavior layer 92, a demographic profile layer 93, an interest area profile layer 94, a buying behavior layer 95, a website behavior layer 96, an email inbox quality layer 97, and a customer reliability layer 98, and a recency-frequency-monetary (RFM) score layer 99, and a basic information layer 100.

Each of the data layers in each customer profile generally includes one or more data fields containing information about the customer. The basic information layer contains data fields indicative of a variety of basic information regarding the customer, such as name, email, whether they have opted in or opted out of email lists, whether they are on a do not call list, whether they are on a blacklist for committing fraud, a lead conversion time lag (i.e. the time between a person becoming a lead and becoming a customer), a total cost to acquire the customer, a phone number, a mobile phone number, the brand the customer was acquired on, and the customer's pricing eligibility (i.e. what price the customer is eligible to be shown).

The transaction fraud profile layer 90 generally includes scoring information that defines the probability that any given transaction for the customer is fraudulent.

The product behavior layer 91 includes data fields indicating the types or categories the customer tends to purchase. These data fields may indicate that the customer has recently purchased a vehicle, or that the customer is recognized as being a buyer of any of the following product categories: baby products, beauty products, cooking equipment and supplies, discounted products, products form high-end brands, home and garden products, home improvement products, luxury goods and jewelry, magazines, outdoor equipment, pet products, sports products, technology products, or travel products. The product behavior layer 91 may also include a data field indicating that the customer is recognized as being a charitable donor.

The transaction behavior information layer 92 includes data fields regarding the customer's transaction behavior, including a customer value, an average order value, a largest order value, a number of attempted orders, a number of paid orders, and a number of refunds and card declines for the customers.

The demographic profile layer 93 includes data fields indicative of demographic information about the customer, including their age, gender, education level, marital status, net worth of household, zip code, number of years at current address, household income, occupation, home value, whether or not the customer owns or rents a home, and whether the customer has children in their household.

The interest area profile 94 includes data fields indicative of different areas of interest to the customer based on their purchases, including business, wellness, news and current affairs, books, blogging, and arts & craft.

The buying behavior layer 95 includes data fields indicative of the customer's buying behavior. These data fields may include the customer's last order date, first order date, the average number of days between the customer's orders, and the number of days since the last order.

The website behavior layer 96 includes data fields indicative of the customer's website behavior. These data fields include the web source platform that captured the customer (i.e. the webpage the user was at when they interacted with an ad that led them to purchase a product), the web medium that captured the customer (i.e. the type of ad the customer interacted with), the web campaign that captured the customer (i.e. the actual campaign by the company that captured the customer), the sales funnel/micro site platform that was used to acquire the customer, and the landing page the customer purchased on (i.e. what page of the company's website the customer landed on after clicking the ad that led to the purchase. A sales funnel/micro site platform allows the creation of offer-based sales funnels that support customer acquisition scenarios. These sales funnels have a limited click path, and allow for a simplified purchase model of upselling the customer. The purchase model includes offering a first product at a first price point and having the customer indicate that they wish to purchase the first product and the first price point, and then immediately offering the customer a one-click upsell opportunity, e.g. providing them a button to click that will add additional or higher-end products to the purchase. The customer is then able to purchase the additional or higher-end products with having to enter any additional customer details. The sales funnel thus provides a company with an easy way of increasing customer value.

The email inbox quality layer 97 includes data fields that represent a score of a customer's email inbox based. These data fields includes a date email address first seen field, a valid syntax field, an inbox receiving field, a velocity field, a popularity field, a date last opened field, an age of the email address field, and a difference between last opened and append date field. The date email address first seen field contains a date that includes a day, month, and year. The valid syntax field and the inbox receiving field with both have a value of “OK” if the email address has a valid syntax and if the email address is still receiving email (e.g. if the hosting service has not canceled or interrupted service to the email address). The valid syntax field and the inbox receiving field have a value of “NOK” if the email address syntax is incorrect (e.g. not having an “@” symbol) or if the email address is no longer receiving emails in the inbox. The velocity field and popularity fields either have a null value or a value that is from 1 to 10, with 10 being highest. The velocity field measures the volume of email contained within the customer's email inbox that is not sent from the company. The popularity field measures the number of different internet service providers (ISP's) that send email to the customer's inbox. The date last opened field contains a date that includes a month and a year. The age of email address contains an integer that is equal to today's date minus the date the date in the date email address first seen field. This is a measure of how long the company has been interacting with this user's email inbox. The difference between last opened and append date is an integer equal to the different between today's date and the date the last time the email inbox was opened. This is a measure of how long it has been since a customer last opened their email inbox and the customer's profile was updated.

The email inbox quality layer 97 also includes an email quality field that is based on the velocity field, the popularity field, the age of email address field, and the difference between last opened and append date. An age of the email address that is less than or equal to 2 months indicates a “Poor” score. An age that is greater than two months and less than 13 months indicates an “Ok” score. An age that is greater than or equal to 13 months indicates a “Good” score. For both the email velocity field and the email popularity field, a value of 0, 1, or 10 indicates a score of “Poor,” a value of 2-4 indicates a score of “Ok,” and a value of 5-9 indicates a score of “Good.” For the difference between last opened and append date, a difference of less than or equal to 2 months indicates a score of “Good,” a difference of greater than 2 months and less than or equal to 3 months indicates a score of “Ok,” and a difference of greater than 3 months indicates a score of “Poor.” These scores are combined to give a final rating on a scale of 1-5. Four “Poor” scores is given a 1. One, two, or three “Poor” scores is given a 2/5, regardless of the fourth score. Four “Ok” scores is given a 3/5. No “Poor” scores and one, two, or three “Good” scores is given a 4/5. Finally, four “Good” scores is given a 5/5.

The email inbox quality layer 97 also includes one or more result override fields. These fields override whatever score value the customer's email inbox is given in certain situations. A fraud warning field contains an indication of potential fraud if the age of the email address is less than or equal to two months, and either: (1) the email velocity field is negative or zero; (2) the email popularity field is negative or zero; or (3) the last open field is negative. If either of these scenarios are true, this can indicate to the company that the email address is not the email address for a legitimate customer, but rather some attempt at fraud. A spam trap field contains an indication of a potential spam trap. A spam trap is an email address that is no longer monitored by the customer but is still capable of receiving emails. In such a case, the hosting service may give the company that is sending the emails a negative rating. The spam trap field indicates a spam trap if each of the following three conditions are true: (1) the email velocity field is greater than 8; (2) the email popularity field is greater than 8; and (3) the difference between last opened and append date field is greater than six months.

A bounce alert field contains an indication of an email address that may bounce back emails sent thereto because the address is no longer active. The bounce alert field indicates a bounce alert if the inbox receiving field has a value of “NOK.” A hard bounce alert field contains an indication that an email address is incorrect. The hard bounce alert field indicates hard bounce alert if the valid syntax field has a value of “NOK.” Customer inboxes that are flagged as spam traps, soft bounces, or hard bounces can be scrubbed from the company's system.

The customer reliability layer 98 includes data fields indicative of the number of orders the customer as attempted to place as compared to the number of orders that have been completely paid for. This data field thus provides an indication of the likelihood that the customer will complete the order (i.e. pay for the order). This data field is particularly important in subscription-based purchase models.

The RFM score layer 99 includes data fields indicative of the customer's RFM score. These data fields may include an RFM score field, and an RFM score by brand field. The RFM score is generated as three separate scores corresponding to the customer's recency, frequency, and monetary scores. To determine the recency score, the entire customer database 80 is sorted by the last order date field and divided into five equal segments. Each customer in the highest ranked segment (i.e. the segment containing customers with the most recent orders) is given a 5, while each customer in the lowest ranked segment is given a 1. The customers in the second, third, and fourth-ranked segments are given a 2, 3, and 4 respectively.

The frequency score is determined in a similar fashion. The customer database 80 is sorted according to the number of fully paid orders and divided into five equal segments. Each customer in the highest-ranked segment (i.e. the segment with the largest number of paid orders) is given a 5, while each customer in the lowest-ranked segment is given a 1. The customers in the second, third, and fourth-ranked segments are given a 2, 3, and 4 respectively. Finally, the monetary score for each customer is determined by sorting the customer database 80 by total customer value. This is a measure of the total amount of dollars the customer has spent. After sorting the customer database 80 into five equal segments, each customer can be given their monetary score. The three resulting scores for each customer are then stored in the RFM score field as a string of integers. For example, a customer who placed in the highest group for the recency score, and second highest group for the frequency score, and the lowest group for the monetary score would have an RFM score of 541.

The RFM score by brand field contains an RFM score for a customer that is based on the brand that customer was acquired on. For example, an individual company may have a plurality of different brands they sell, such as shoes, workout clothing, outerwear, fitness equipment, etc. The RFM by brand score could include an RFM score based on customers who first purchased shoes from the company before any of the company's other brands. The RFM score for shoe customers is determined in a similar fashion as the overall RFM score, but is determined by looking at a database of customers that includes only those customers who first purchased shoes, rather than all of the company's customers.

The RFM score data field can be utilized by each of the clouds. However, certain of the clouds are not capable of analyzing the RFM score data field when it is organized as a string of integers. For example, the analytics cloud may want to group customers by RFM score or individual component of RFM score, or bound customers having an RFM score within a certain range. However, the analytics cloud cannot group data stored as string of integers. As such, the RFM score data field is converted to a text string and stored within the customer profile alongside the RFM score organized as a string of integers. This allows allow of the clouds of the software system to be able to utilize and analyze each customer's RFM score.

Many of the data fields within each customer profile in the customer database must be manipulated to work across each of the service cloud 20, marketing cloud 30, customer acquisition cloud 40, community cloud 50, and application cloud 60. In one embodiment of the present invention, data fields in each customer profile that contain dates must be manipulated or otherwise transformed in order work properly. For example, marketing cloud 30 is not capable of manipulating the data fields in a customer profile when the data fields are stored as date fields. Thus, certain data fields must be transformed from date fields to integer fields. These data fields can include the days since last order data field, the average number of data between orders field, the days between average order and last order field, and the lead conversion time lag field.

In another embodiment of the present invention, certain of the above-disclosed data fields are related to mathematical expressions involving the data in the customer profile. These data fields may be organized as formula fields. For example, the age of email address field is a formula field expressed as a field having the current date minus the date email address first seen field. In another example, the total customer value field is a formula that adds the value of each of the customer's orders. Certain of the clouds of the system are incapable of working properly with formula fields. For example, marketing cloud 30 cannot work with formula fields. As such, these formula fields, (i.e. the structure of the data within these data fields) must be transformed from expressions involving integers to an actual integer field, such that the data fields are organized as integers expressing the outcome of the mathematical expression. Thus, any of the above-disclosed data fields that contains formulas are transformed into integer fields and stored as both formula fields and integer field.

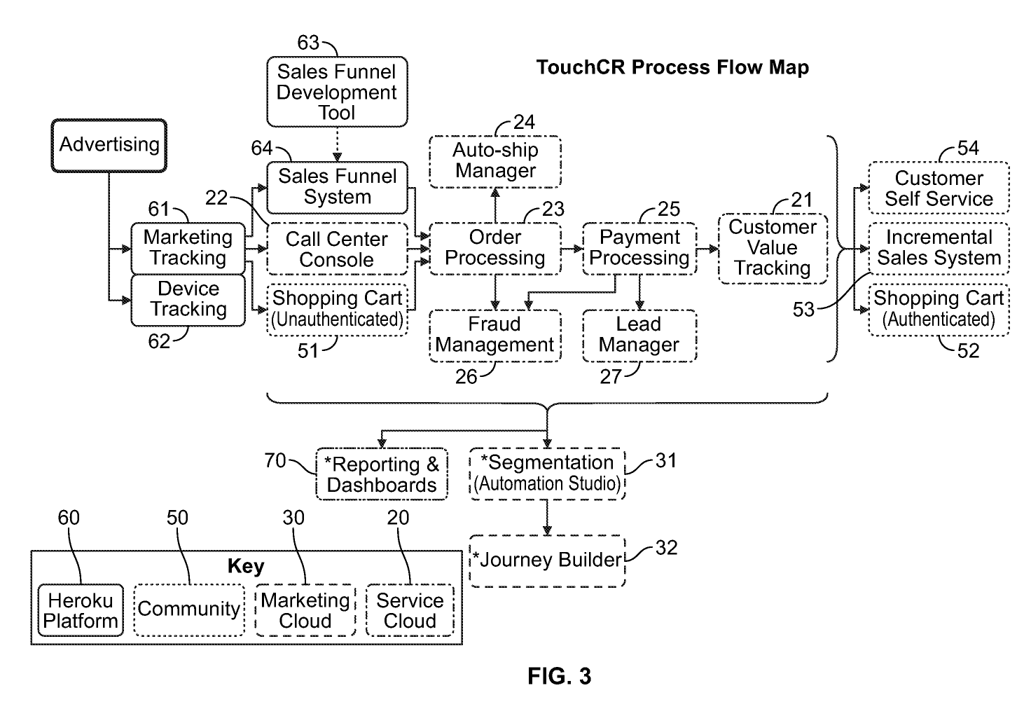

FIG. 3 shows a flow map representing how software modules can interact or how a user of the system can flow through the modules. Each of the modules in FIG. 2 is designated by its cloud number and by an individual number incremented by one number greater starting from the base cloud number. For example, a marketing tracking module is in the application cloud 60 and is the first module discussed, and, therefore, is designated by 61.

The marketing tracking module 61 provides for standard media-tracking parameters to be passed through with each customer and each order online to enable the tracking of revenue source by ad/media type and execution. This mechanism enables ad conversion return on investment (ROI) calculation recording where the customer was initially acquired and uniquely where all subsequent orders were originated. The marketing tracking module 61 tracks customers through both online campaigns and telephone campaigns. Parameters obtained from such a marketing outreach can be a utm_source, a utm_medium, a utm_campaign, a utm_content, a utm_term, a sales funnel name, a referral domain, and a landing page url. Parameters obtained from such a marketing outreach can be a landing page url, a sales funnel.

A customer value tracking module 21 provides for management of customer data to track at an individual's account level including information as to the individual's first order, most recent order, customer value, ad conversion ROI, transaction frequency, average order value, and the number of failed and refunded orders. The value tracking module allows for the use of Recently, Frequency and Monetary value calculation to segment and enable decisions to effectively monetize customers by identifying and managing higher and lower value clients more appropriately.

A segmentation module 31 surfaces data through standard integration mechanisms to make all tracking data available in a tool journey builder 32 and other tools within the marketing cloud 30.

An authenticated shopping cart module 51 provides standard shopping cart capability, incorporated into the community cloud 50, through unauthenticated pages. Products and services can be designated by category, product, product variants, and provide functions including add to cart, wish list, coupon system, auto-ship option, checkout, and upsell. The unauthenticated shopping cart module 51 also provides standard price book pricing. The unauthenticated shopping cart module 51 interacts with the marketing tracking module 61 and the order processing module 23.

A shopping cart (authenticated) module 52 provides the same functionality of module 51 through authenticated pages. Module 52 also provides individual customer value tracking to adjust pricing based on the individual customer. Module 52 also provides a coupon system, auto-ship options and an “add money to account capability” to offer customers “money” to spend.

A journey builder tool 32 is provided to allow for planning and tracking of marketing campaigns through various on-line and off-line channels with transactional information being passed through to the service cloud 20.

A lead manager module 27 is provided for managing customers, creating follow-up method for those customers who abandon orders due to order failures, credit card issues or other forms of abandonment, to reconnect with those customers and enable monetization of these relationships.

An incremental sales system module 53 is provided to allow an existing customer to purchase offer using a one-click-sale mechanism using a community authentication mechanism using current card information and current billing and shipping address. Module 53 also provides dynamic construction of offers and URL tracking used to select an offer for a client.

A customer self-service module 54 surfaces order information and a customer profile using standard templates.

A call center console module 22 provides a call center for customers to contact. The call center module 22 provides a call representative with a script to sell products across multiple brands and to post the initial transaction information through a one screen management system.

An order processing module 23 provides for the creation and management of orders including duplicate customer identification, blacklist tracking, order failure exception management, and automatic community user creation post order.

An auto-ship manager module 24 provides for the creation and management of auto-ship parameters based on offer configuration and generation of auto-ship order and processing of payments based on frequency requirements using existing customer details.

A payment processing module 25 provides an integrated payment gateway using a partner system providing payment processing capabilities with 26 payment providers. It provides a pci 3 compliant handling of credit card information for a completely tokenized management of the card data (no card data help in system), and the ability to use current card for auto-ship and repeat orders on any channel.

A device tracking module 62 provides for fingerprinting of devices so that multiple devices used by an individual consumer can be linked to his or her single unique consumer account. The module 62 also provides for device tracking, fraud detection and reporting.

A fraud tracking and management module 26 is provided for capturing all of a client browser information and fingerprinting of said device to allow for tracking of click fraud. The module 26 is integrated into external api based enquiry system matching credit card, consumer, billing address to identify fraud or stolen cards pre-transaction completion. Module 26 also provides for exception handing and black list creation for clients with multiple failed cards, multiple refunds, chargebacks, and multiple reshipment requests.

A sales funnel development tool module 63 is provided to enable the creation of sales funnels pages without coding using HTML drag and drop development interface shown in FIG. 3.

A sales funnel system module 64 is provided for the management and positioning of online offers with the ability to offer variations and upsell paths both on the web and the call center. Module 64 also provides for the provisioning of direct-to-sale order forms through an offer-based approach to sell a single item or a package deal and provide upsell packages post the initial transaction. Module 64 also provides landing pages, sales pages, order forms, upsell pages and thank you pages. Module 64 further configures offers within salesforce and pricing and product information is dynamically inserted into order forms—data passed through application cloud 60. Marketing tracking, device tracking are built in to this module. Module 64 provides for api based integration for order processing into salesforce using rest api. Order forms incorporate coupon, auto-ship capability, upsell post transaction, cart abandon and cart error lead management.

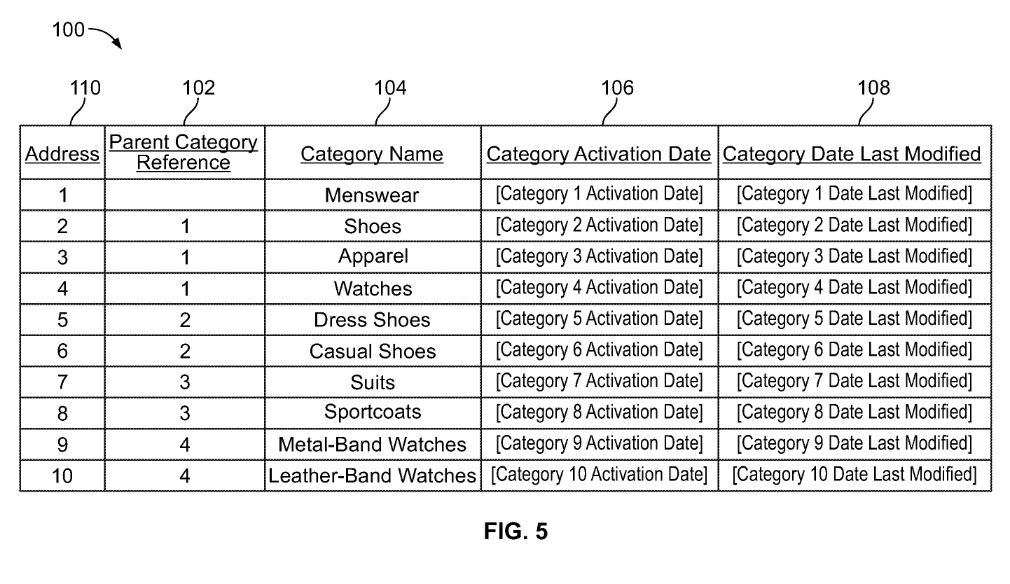

FIG. 5 illustrates a self-referential table used in embodiments of the present invention. The self-referential table allows the storage of a large and multi-layered table of items. For example, the self-referential table could be a category tree for products. Previously, such category tree tended to have an individual table for each category, where each table pointed back to its parent category. For example, a first table could be a “shoe” table that is the initial category and thus does not point to any table. Second, third, and fourth tables could be tables for dress shoes, casual shoes, and boots. Each of these tables would include a reference back to the “shoe” table. Each of the second, third, and fourth tables could a plurality of sub-tables. Thus, the category tree for these products could grow larger and larger. However, standard querying language is not capable of searching further than two tables deep. Any tables past the first sub-category would not be searchable.

Accordingly, the system of the present invention utilizes a logical table 100 that is self-referencing, as shown in FIG. 5. The logical table includes a plurality of rows and a plurality of columns, thereby forming a plurality of cells. Each row corresponds to a category of products. Generally, each row has a parent row that corresponds to a parent category of products for any given product. For example, a row corresponding to “shoes” could be the parent row of a row corresponding to “brown shoes,” as “shoes” is the parent category to “brown shoes.” Each row has a respective plurality of cells containing information. The information in the cells generally includes a product category name, a product category activation date, a date the product category was last modified, and a parent category reference. Thus, the plurality of columns is organized as a parent category reference column 102, product category name column 104, a product category activation date column 106, and a category date last modified column 108. The parent category reference of a row contains some reference to that row's parent row. For example, the parent category reference of a row may contain the address 110 within the logical table of that row's parent row. In addition, the logical table includes a first row that corresponds to a top-level product category. The parent category reference of this first row is generally blank or contains a null value, i.e. a value indicating that the row corresponds to the top-level category.

FIG. 5 illustrates an exemplary logical table 100. As shown, the first row contains the top-level product category, “Menswear.” Each subsequent row contains a different product category, indicating the parent category reference 102, the category name 104, the category activation date 106, and the category date last modified 108. Rows 2, 3, and 4 are both sub-categories of the top-level category, and thus parent category reference 102 for each of those rows contains “1,” which is the address of the top-level category. Row 2 is the parent row for rows 5 and 6. Row 3 is the parent row for rows 7 and 8. Row 4 is the parent row for rows 9 and 10. As is shown, the parent category reference for each of those rows refers to the address of the parent row. Thus, the logical table 100 of FIG. 5 is capable of containing a large category tree that is searchable by standard querying language. Because all of the categories and sub-categories are contained in a single table, standard querying language is able to search the categories without issue.

According to one embodiment of the present invention, a method of utilizing a customer profile is as follows. First, historical customer and transactional data is loaded into the customer database 80 for one or more customers. Second, one or more financial metrics about the one or more customers are determined. Third, additional email and demographic data is obtained from a variety of outside sources. Fourth, the historical behavior of the one or more customers may be analyzed. Fifth, the one or more customers may be segmented by behavior data, demographic data, and customer value. Finally, tailored journeys may be created for each customer based on the segmentations.

In another embodiment, customer data including transactional data and non-transactional data is obtained. The customer data includes first, second, and third subsets of customer data. The first subset of customer data is transformed from a first type to a second type, and both types of data are stored. The second subset of customer data is transformed from a third type to a fourth type, and both types of data are stored. The third subset of customer data is transformed from a fifth type to a sixth type, and both types of data are stored. The first type of the first subset may be sent to at least one of the service cloud, the marketing cloud, the customer acquisition cloud, or the community cloud. The second type of the first subset may be sent to the analytics cloud. The third type of the second subset may be sent to at least one of the service cloud, the customer acquisition cloud, the community cloud, or the analytics cloud. The fourth type of the second subset may be sent to the marketing cloud. The fifth type of the third subset may be sent to at least one of the service cloud, the customer acquisition cloud, the community cloud, or the analytics cloud. The sixth type of the third subset may be sent to the marketing cloud.

The present invention is embodied in non-transitory computer readable instructions when stored in a computer memory and run on a processor carries out the functions set forth herein. A standard computer with a memory, a processor, a display screen, and an input device is capable of executing the computer-readable instructions of the present invention.

While the present invention is described in connection with what is presently considered to be the most practical and preferred embodiments, it should be appreciated that the invention is not limited to the disclosed embodiments, and is intended to cover various modifications and equivalent arrangements included within the spirit and scope of the claims. Modifications and variations in the present invention may be made without departing from the novel aspects of the invention as defined in the claims. The appended claims should be construed broadly and in a manner consistent with the spirit and the scope of the invention herein.

1. A business to consumer enterprise software system comprising:
a computer having a memory and a processor;
non-transitory computer-readable instructions stored in the memory when executed by the processor provides the following modules:
a service cloud for order processing, auto-ship management, reporting, customer value tracking, marketing tracking, call center console, lead manager, fraud alert and payment processing;
a marketing cloud for customer journey and customer segmentation;
a customer acquisition cloud for sales funneling, and sales funnel development;
a community cloud to provide a customer shopping cart, a customer self-service function, and an incremental sales system; and
an analytics cloud to provide segmentation and analysis of customer data points.

2. A method of analyzing a customer profile within a business to consumer enterprise software system, the software system providing a service cloud, a marketing cloud, a customer acquisition cloud, a community cloud, and an analytics cloud, the method comprising:
obtaining customer data, the customer data including transactional data and non-transactional data;
transforming a first subset of customer data from a first type to a second type, both the first type and the second type of the first subset of customer data being stored in the customer profile;
transforming a second subset of customer data from a third type to a fourth type, both the third type and the fourth type of the second subset of customer data being stored in the customer profile;
transforming a third subset of customer data from a fifth type to a sixth type, both the fifth type and the sixth type of the third subset of customer data being stored in the customer profile;
sending the first type of the first subset of customer data to at least one of the service cloud, the marketing cloud, the customer acquisition cloud, or the community cloud;
sending the second type of the first subset of customer data to the analytics cloud;
sending the third type of the second subset of customer data to at least one of the service cloud, the customer acquisition cloud, the community cloud, or the analytics cloud;
sending the fourth type of the second subset of customer data to the marketing cloud;
sending the fifth type of the third subset of customer data to at least one of the service cloud, the customer acquisition cloud, the community cloud, or the analytics cloud;
sending the sixth type of the third subset of customer data to the marketing cloud.

3. The method of claim 2, wherein the first subset of customer data includes data fields related to a recency-frequency-monetary (RFM) score.

4. The method of claim 3, wherein the RFM score is determined at in part by (i) ranking and segmenting a customer database according to a date of most recent order; (ii) ranking and segmenting the customer database according to a number of fully paid orders; and (iii) ranking and segmenting the customer database according to a total of dollars spent at the business.

5. The method of claim 3, wherein the first type of the first subset of customer data includes data fields organized as a string of integers.

6. The method of claim 3, wherein the second type of the first subset of customer data includes data fields organized as a text string.

7. The method of claim 2, wherein the second subset of customer data includes data fields related to dates.

8. The method of claim 7, wherein the third type of the second subset of customer data includes data fields related to dates that are organized as date fields.

9. The method of claim 7, wherein the fourth type of the second subset of customer data includes data fields related to dates that are organized as integers.

10. The method of claim 7, wherein the data fields related to dates include a date of a customer's first order, a date of the customer's last order, a date of the customer first being identified as a lead to the business, and a date of the customer's account creation with the business.

11. The method of claim 2, wherein the third subset of customer data includes data fields related to mathematical expressions involving the transactional data and the non-transactional data.

12. The method of claim 11, wherein the fifth type of the third subset of customer data includes data fields organized as formulas.

13. The method of claim 11, wherein the sixth type of the third subset of customer data includes data fields organized as integers indicating an outcome of the mathematical expressions.

14. The method of claim 12, wherein the non-transactional data includes data related to an email inbox of the customer.

15. The method of claim 14, wherein the data related to the email inbox of the customer is used to determine an email quality score.

16. The method of claim 14, wherein the data related to the email inbox of the customer is used to determine whether the customer's email inbox indicates a fraud alert, a bounce alert, or a spam trap.

17. The method of claim 14, wherein the data related to the customer's email inbox includes an email velocity data field, an email popularity field, an age of email field, and a difference between last opened and append field.

18. A logical table for organizing a plurality of product categories, the logical table comprising:
a plurality of rows, each row of the plurality of rows corresponding to a respective category of products, each row having a respective parent row corresponding to a respective parent category of products; and
a plurality of columns intersecting the plurality of rows to define a plurality of cells, each row having a respective sub-plurality of cells, wherein each respective sub-plurality of cells includes information related to the category of products corresponding to each row, the information including a product category name, a product category activation date, a date last modified, and a respective parent category reference, the respective parent category reference indicating the respective parent row of each row.

19. The logical table of claim 18, wherein each respective parent category reference is an address of the parent row within the logical table.

20. The logical table of claim 19, wherein the plurality of rows includes a first row corresponding to a top-level product category, and wherein the parent category reference of the first row is blank or contains a null value.
